(19) United States
(12) Patent Application Publication
(10) Pub. No.: US 2012/0055305 A1
(43) Pub. Date: Mar. 8, 2012

(54) ROLLER-TYPE COMPRESSION-INCISION-CUTTING UNIT

(75) Inventor: Claudio Betti, Imola (IT)

(73) Assignee: IMA INDUSTRIES S.R.L., 40064 Ozzano Emilia (Bologna) (IT)

(21) Appl. No.: 13/321,124

(22) PCT Filed: May 14, 2010
(86) PCT No.: PCT/IB2010/052148

§ 371 Date: Nov. 17, 2011

(30) Foreign Application Priority Data
May 25, 2009 (IT) BO2009A000335

(51) Int. Cl. B26D 7/06

(52) U.S. Cl. 83/436.3

(57) ABSTRACT

A roller-type compression-incision-cutting unit for packaging material webs comprises: a motor-driven roller (2) provided with at least one projecting incision-cutting profile (3); a driven counter-roller (4) provided with at least one abutting counter-profile (5); kinematic means (6) for directly transmitting motion, in a synchronised fashion, between the roller (2) and the counter-roller (4), the kinematic means being connected to respective shafts (2a, 4a); adjustable pusher elements (7), adapted to allow an incision or cutting contact between the roller (2) and the counter-roller (4); at least one rolling element (10, 11) interposed between the roller (2) and the counter-roller (4), and adapted to separate the rotation of the motor-driven roller (2) from the rotation of the thrust rings of the driven counter-roller (4).

### TECHNICAL FIELD

This invention relates to a roller-type compression-incision-cutting unit, in particular which can be used on machines for making pods containing infusion products.

### BACKGROUND ART

In the above-mentioned machines a roller-type compression-incision-cutting unit is often used, that is to say, a station comprising roller-type pressers or knives adapted, respectively, to compress, or incise or cut packaging material.

For example, said units allow continuous filter paper webs, which have successive closed pods containing the dose of product, to be cut as they pass between two rotating rollers. The latter have respective profiles substantially copying the desired shape of the pod.

These units comprise:
a motor-driven roller provided with one (or more) projecting profiles with respective blades forming the actual cutter-knife;
a driven counter-roller, provided with one (or more) abutting counter-profiles and whose axis is parallel with the roller;
kinematic means for directly transmitting motion between the motor-driven roller and the counter-roller, typically gear wheels;
adjustable pusher elements, acting on the counter-roller for allowing calibrated contact between the roller and the counter-roller in such a way as to apply an operating pressure on the filter paper web.

Basically, the roller and the counter-roller, whose axes of rotation are parallel, are made to rotate in a synchronised fashion by a direct gear transmission system in such a way that they rotate in opposite directions.

The counter-roller is brought into contact (with a thrust value that can be precisely adjusted) with the roller to apply the operating pressure.

The thrust adjustment is essential and must be extremely precise to avoid premature wear of the profile blades. That problem occurs because, without a precise zone for discharging the forces, concentrated forces would be generated, due to the thrust of the counter-roller on the roller-counter-roller contact surfaces, which vary in size and which are distributed along the contact generatrix between the roller and the counter-roller, in particular on the incision-cutting profiles.

To avoid an excessive load on the blades, at the ends of the roller and the counter-roller thrust elements and supporting elements are respectively made (for example thrust rings and supporting rings), integral with the respective roller and counter-roller and adapted to form precise contact points on which most of the thrust of the counter roller onto the roller can be discharged, consequently lightening the load on the operating contact zones, which in this way operate in an optimum fashion.

The operating pressure is usually obtained by making the projecting profiles in such a way that, when the thrust rings and the supporting rings are brought into contact with each other, the profiles elastically deform on contact with the counter-roller, generating the operating pressure.

However this cutting unit has a disadvantage due precisely to the presence and structure of these two rings positioned on the roller and the counter-roller.

It was noticed that with this configuration there is a double transmission of motion between the roller and the counter-roller: one by the kinematic means described above and one by the thrust rings and the supporting rings which act like friction wheels. Since the latter, due to processing errors (tolerances on diameters, eccentricity, etc.) cannot be exactly the same as the corresponding diameters of the pitch circles of the gears belonging to the kinematic means, dragging occurs at the line of contact between the thrust rings and the supporting rings.

This difference in the surface speed of the two rollers creates, as a direct consequence, stresses and friction which are unwanted and harmful to the gear transmission system, with possible increased wear or damage to the gear teeth.

In addition, it should be noticed that this problem may also arise on new units which have just been assembled, due to possible small differences between the diameters of the rollers and the thrust rings caused by processing imprecisions/tolerances.

### DISCLOSURE OF THE INVENTION

The aim of this invention is therefore to overcome these disadvantages by providing a roller-type incision-cutting unit structured in such a way that it allows correct thrust between the roller and the counter-roller, substantially maintaining unchanged the construction architecture of the rollers, and precise, reliable transmission of motion in a synchronised fashion between said rollers.

Accordingly, the invention achieves that aim with a roller-type compression-incision-cutting unit comprising the technical features described in one or more of the appended claims.

A roller-type compression-incision-cutting unit made in accordance with the invention is advantageously applied in the cutting of packaging material, for example filter paper webs containing infusion products.

### BRIEF DESCRIPTION OF THE DRAWINGS

The technical features of the invention, with reference to the above aims, are clearly described in the claims below and its advantages are apparent from the detailed description which follows, with reference to the accompanying drawing which illustrates a preferred, non-limiting embodiment, showing a front view with some parts in cross-section to better illustrated others, of the roller-type incision-cutting unit in accordance with this invention.

### DETAILED DESCRIPTION OF THE PREFERRED EMBODIMENTS OF THE INVENTION

With reference to the accompanying drawing, the roller-type unit according to this invention, labelled 1 as a whole, is used for the incision or cutting of continuous filter paper webs.

On these webs (not illustrated in the accompanying drawing) a series of closed pods is formed, each containing a dose of infusion product.

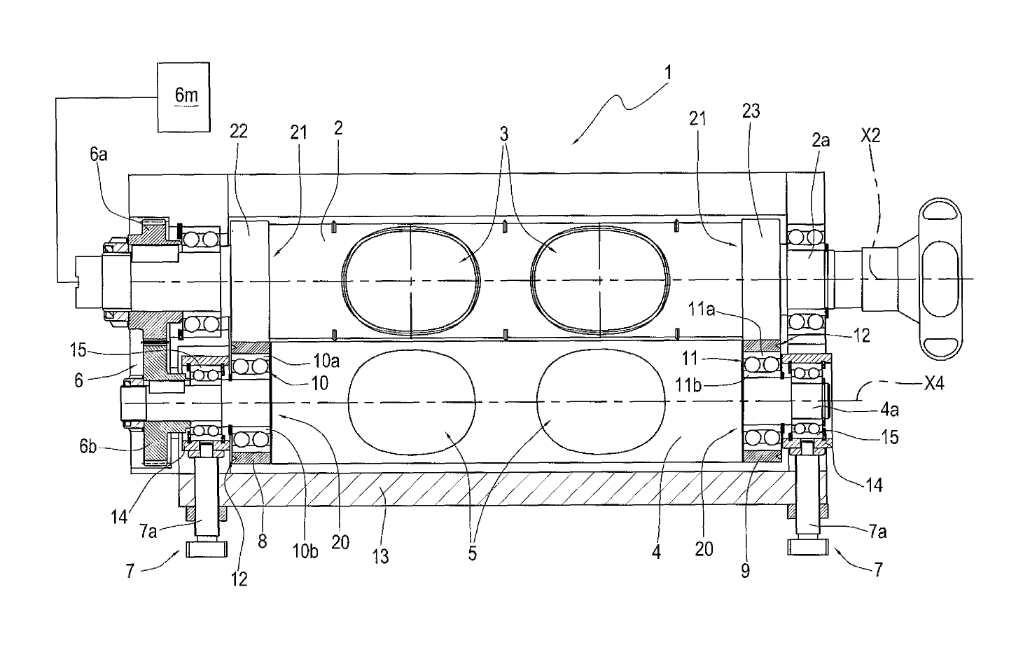

As the accompanying drawing shows, the roller-type incision-cutting unit 1 basically comprises:
a motor-driven roller 2 defining a first axis X2 and provided with one or more (for example two are visible in the accompanying drawing) compression-incision-cutting profiles 3 (in this case having an elliptical shape) arranged side by side and having respective blades projecting from them;
a driven counter-roller 4, mounted on a second shaft 4a and provided with one or more (for example two are visible in the accompanying drawing) respective abutting counter-profiles 5, the counter-roller 4 defining an axis X4 which is parallel with the axis X2 of the motor-driven roller 2;
kinematic means 6 for directly transmitting motion, in a synchronised fashion, between the motor-driven roller 2 and the counter-roller 4, the kinematic means being connected to a first shaft 2a supporting the roller 2 and to a second shaft 4a supporting the counter-roller 4;
thrust elements 20 connected to the ends of the counter-roller 4 and adapted to make contact with supporting elements 21 connected to the ends of the roller 2;
pusher elements 7, advantageously adjustable, adapted for pushing the thrust elements 20 into contact with the supporting elements 21; and
at least one element, advantageously of rolling type, interposed between the roller 2 and the counter-roller 4; in the embodiment shown in FIG. 1, there being two rolling elements 10, 11, which are substantially identical.

The motor-driven roller 2 is made to rotate about the first axis X2 by a drive unit 6m, schematically illustrated with a block. The first shaft 2a is fitted with a driving gear wheel 6a, which meshes with a driven gear wheel 6b fitted on the shaft 4a of the counter-roller 4.

The pusher elements 7 are mounted at the ends of the second shaft 4a, at the ends of the counter-roller 4, and comprise a pair of screws 7a connected in such a way that they can be tightened and slackened to a supporting frame 13, and pushing shoes 14 for supporting the roller 4 against the roller 2.

Inside the shoe 14 there is a bearing 15, allowing rotation of the counter-roller 4.

Therefore, by tightening or slackening the screws 7a a radial thrust is created on the counter-roller 4 towards the roller 2, making use of the play between the toothing of the driving gear wheel 6a and the driven gear wheel 6b.

Advantageously, in the embodiment in FIG. 1, the thrust elements 20 comprise thrust rings 8, 9 positioned at the respective ends of the counter-roller 4 and mounted on the respective rolling elements 10, 11, therefore being in tangential contact with the bearing elements 21, which also in the embodiment in FIG. 1, are illustrated as bearing rings 22, 23 made integral with the roller 2.

In an alternative embodiment, not illustrated, the thrust elements 20 may be directly the rolling elements 10, 11 and the thrust rings 8, 9 can be omitted.

If necessary, the thrust rings 8, 9 help to further stiffen the respective rolling elements 10, 11.

In the embodiment with thrust rings illustrated in FIG. 1, each rolling element 10, 11 is interposed between the respective thrust ring 8, 9 and the counter-roller 4. This allows rotation of the respective thrust ring 8, 9, in contact with the bearing rings 22, 23, to be separated from the rotation of the counter-roller 4.

Each of the rolling elements 10, 11 is positioned coaxially on the shaft 4a of the second, counter-roller 4.

In terms of positioning, each thrust ring 8, 9 is interposed and in rotary contact between an external part 10a, 11a of the respective rolling element 10, 11 and the bearing rings 22, 23, in such a way that it can rotate relative to the counter-roller 4 driven by the motor-driven roller 2.

Moreover, an internal part 10b, 11b of the rolling element 10, 11 is coupled to the second shaft 4a.

The internal part 10b, 11b of the rolling element 10, 11 rotates with the shaft 4a of the second roller 4.

Advantageously, each rolling element comprises a bearing 10, 11 (in this case a ball bearing, by way of example only) with an external ring in contact with the respective thrust ring 8, 9 and an internal ring mounted on and constrained to the second shaft 4a, in such a way as to keep the speed of rotation of the driven counter-roller 4 independent of the speed of rotation of the thrust rings 8, 9, whose rotation is driven by friction by the bearing rings 22, 23 of the motor-driven roller 2.

The rings 8, 9 are advantageously made of metal, giving the rolling elements 10, 11 greater stiffness.

Therefore, thanks to the presence of the bearings interposed between the counter-roller and the thrust rings, a sort of “friction wheel transmission system” is created.

In practice, the system derived from the configuration described provides one driving unit (motor-driven roller 2) and two independent driven units: the counter-roller 4 whose rotation is driven by the kinematic direct transmission means, and the external parts 10a, 11a of the rolling elements (or the thrust rings if present) whose rotation is driven by the bearing rings 22, 23 of the roller 2 by means of friction.

The system designed in this way allows the motor-driven roller 2 and the counter-roller 4 to be synchronised thanks to the pair of gear wheels, whilst the external parts 10a, 11a of the rolling elements (or the thrust rings 8, 9 if present) are driven by the roller 2 thanks to their tangential friction contact or point, but their rotation is independent of the rotation of the counter-roller 4. In other words, thanks to the bearings interposed between the roller 2 and the counter-roller 4, at the thrust elements and the supporting elements, the roller 2 does not transmit a rotational torque to the counter-roller 4.

Since they can rotate independently of the rotation of the counter-roller 4, the first external parts 10a, 11a of the rolling elements (or the thrust rings 8, 9 if present) and the roller 2 rotate with the same respective surface speeds, thanks to respective friction zones.

Therefore, said operating condition prevents potential speed differences between the thrust elements and the bearing elements from affecting the gear transmission system.

Moreover, since the rolling elements (or the thrust rings if present) roll on the roller substantially without dragging, wear associated with the external parts of the rolling elements (or with the thrust rings if present) is in any case extremely limited. In short, the angular rotation transmitted by the roller 2 to the rolling elements, for any speed adopted by the rolling elements, does not affect the rotation of the counter-roller 4, which remains driven only by the gear transmission system connected to the second shaft 4b.

The compression-incision-cutting unit just described may be modified in several ways, without thereby departing from the scope of the inventive concept.

For example, the kinematic direct transmission means may comprise elements other than the driving gear wheel and the driven gear wheel illustrated with reference to FIG. 1. For example, the transmission means may be of the belt type, or of the type with an independent drive unit.

As regards the rolling elements connecting the roller and the counter-roller, the ball bearings illustrated may be substituted with wheels, roller and/or needle bearings, whether normal or pre-loaded. The rolling elements may also be substituted with bushings or other sliding elements.

Moreover, in an alternative embodiment, the thrust rings may be omitted, so that the rolling elements make contact directly with the roller. If bearings or wheels which have an external ring and an internal ring are used, the external ring will make contact directly with the roller, whilst the internal ring will be connected to the counter-roller (or to the shaft supporting the counter-roller).

In an alternative embodiment the pusher elements may comprise elastic elements, or pneumatic or hydraulic actuators.

An incision-cutting unit according to the invention may advantageously be used for the compression, incision or cutting of paper, cardboard and plastic materials in general for packaging and wrapping products.

1. A roller-type compression-incision-cutting unit (1) for packaging material comprising:
a motor-driven roller (2) defining a first axis (X2) and provided with at least one projecting compression-incision-cutting profile (3); said roller (2) being adapted to rotate about said first axis (X2);
a driven counter-roller (4) defining a second axis (X4) parallel with the first axis (X2), said counter-roller (4) being provided with at least one abutting counter-profile (5) and being adapted to rotate about said second axis (X4);
kinematic means (6) for directly transmitting motion, in a synchronised fashion, between the motor-driven roller (2) and the counter-roller (4), the kinematic means (6) being connected to a first shaft (2a) supporting the roller (2) and to a second shaft (4a) supporting the counter-roller (4);
thrust elements (20) connected to the counter-roller (4) adapted to make contact with bearing elements (21) connected to the roller (2);
pusher elements (7) for pushing the thrust elements (20) into contact with the bearing elements (21);
said unit (1) being characterised in that it also comprises at least one rolling element (10, 11), interposed between said roller (2) and said counter-roller (4), being adapted to allow the rotation of the counter-roller (4) to be driven only by the direct transmission kinematic means (6).

2. The unit according to claim 1, wherein said at least one rolling element (10, 11) is arranged on said second shaft (4a) of said counter-roller (4).

3. The unit according to claim 1 , wherein said thrust elements (20) comprise at least one thrust ring (8, 9) coupled to said at least one rolling element (10,11).

4. The unit according to claim 3, wherein each of said at least one thrust rings (8, 9) is interposed between and rotatably in contact with an external part (10a, 11a) of said at least one rolling element (10, 11) and said bearing elements (21), in such a way as to freely rotate with respect to said counter-roller (4), said counter-roller (4) being driven by said roller (2) by means of the kinematic means (6).

5. The unit according to claim 3, wherein said at least one rolling element (10, 11), at its internal part (10b, 11b), is coupled to said second shaft (4a) of the counter-roller (4); the internal part (10b, 11b) of the rolling element (10, 11) being integral with the counter-roller (4).

6. The unit according to claim 1, wherein said at least one rolling element comprises a rolling bearing (10, 11) interposed between said roller (2) and said counter-roller (4), in such a way that, at the thrust elements (20) and the bearing elements (21), the roller (2) does not transmit a rotational torque to the counter-roller (4).

7. The unit according to claim 1, wherein each of said at least one thrust rings (8, 9) is made of metal.

8. The unit according to claim 1, comprising two rolling elements, each comprising a rolling bearing (10, 11), said two rolling elements being arranged at respective ends of the counter-roller (4).

9. The unit according to claim 3, comprising at least two thrust rings (8, 9) mounted on respective rolling bearings (10, 11) arranged at respective ends of the counter-roller (4) and in tangential contact with at least two bearing elements (21) of the roller (2).

10. The unit according to claim 1, wherein said packaging material consists of filter paper webs containing infusion products.
